(19) United States
(12) Patent Application Publication
(10) Pub. No.: US 2026/0369742 A1
(43) Pub. Date: Nov. 19, 2026

(54) BATTERY CASE FOR VEHICLE

(71) Applicants: Hyundai Motor Company, Seoul (KR); Kia Corporation, Seoul (KR)

(72) Inventors: Yu Ri Oh, Hwaseong (KR); Gyeong Hwan Gong, Hwaseong (KR); In Gook Son, Hwaseong (KR); Hyun Chang Kang, Hwaseong (KR)

(21) Appl. No.: 19/352,242

(22) Filed: Oct. 7, 2025

(30) Foreign Application Priority Data
May 19, 2025 (KR) 10-2025-0064790

(51) Int. Cl. H01M 10/658; A62C 3/16; H01M 10/625; H01M 50/249; H01M 50/271; H01M 50/367

(52) U.S. Cl. CPC H01M 10/658; A62C 3/16; H01M 10/625; H01M 50/249; H01M 50/271; H01M 50/367

(57) ABSTRACT

A battery case for a vehicle is disclosed. The battery case may include a case member configured to partition a battery accommodation space from an outside, and a flame protection cover installed between the case member and a battery accommodated in the battery accommodation space and configured to form a space between the flame protection cover and the case member.

### CROSS-REFERENCE TO THE RELATED APPLICATION

This application claims, under 35 U.S.C. § 119(a), the benefit of Korean Patent Application No. 10-2025-0064790, filed May 19, 2025, in the Korean Intellectual Property Office, the entire contents of which are incorporated herein by reference.

### BACKGROUND

### a Technical Field

The present disclosure relates to a structure of a battery case installed in a vehicle.

### b Description of the Related Art

Electric vehicles (EVs), or hybrid electric vehicles (HEVs), are equipped with one or more battery packs to supply electric power to a motor necessary for driving of the vehicle. The battery pack has a configuration in which a plurality of battery modules is accommodated in a battery case. Each battery module is constituted by a plurality of stacked battery cells. The battery case may be configured through inclusion of a lower case and an upper case that are assembled together to form an accommodation space for accommodating the plurality of battery modules.

For reference, in the following description, the term “battery” may be understood to encompass both the battery module and the battery cell.

The above matters disclosed in this section are merely for enhancement of understanding of the general background of the disclosure and should not be taken as an acknowledgement or any form of suggestion that the matters form the related art already known to a person skilled in the art.

### SUMMARY

The present disclosure has been proposed to solve the above-mentioned problems and an aspect of the present disclosure is to provide a battery case for a vehicle which, in the event of a fire occurring in a battery module or a battery cell accommodated in the battery case, aids in preventing flames from leaking outside of the battery case, and ensures stable maintenance of a venting passage, thereby suppressing spread of the fire.

Aspects of the present disclosure are not limited to the above-described aspect, and other aspects of the present disclosure not yet described will be more clearly understood by those skilled in the art from the following detailed description.

In accordance with the present disclosure, the above and other aspects may be accomplished by the provision of a battery case for a vehicle comprising a case member configured to partition a battery accommodation space from an outside, and a flame protection cover installed between the case member and a battery accommodated in the battery accommodation space and configured to form a space between the flame protection cover and the case member.

The flame protection cover may be configured to be installed to be spaced apart from the battery to form a venting passage between the flame protection cover and the battery.

The space and the venting passage may be disposed in parallel to each other under a condition that the flame protection cover is disposed between the space and the venting passage.

The flame protection cover may be provided in plural such that a plurality of flame protection covers correspond to battery modules accommodated in the accommodation space, respectively.

The flame protection cover may be constituted by a single member configured to partition all battery modules accommodated in the accommodation space from the case member.

The flame protection cover may comprise a flat plate portion configured to form the space, and a coupling portion bent from the flat plate portion and coupled to the case member.

The coupling portion may be configured to be provided at opposite ends of the flat plate portion.

A plurality of communication holes may be formed at the flat plate portion.

The communication holes formed at the flat plate portion may be configured to be disposed in alignment with vent holes of the battery cell.

The communication holes formed at the flat plate portion may be formed to have a shape resembling a shape of the vent holes of the battery cell.

The flat plate portion may be constituted by a simple, uniform-thickness flat plate without having holes.

A fire-resistant material may be provided in the space between the flame protection cover and the case member.

A fire-extinguishing material may be provided in the space between the flame protection cover and the case member.

The flame protection cover may be provided with a blocking guide configured to block direct exposure of the case member to flames generated in the battery and to guide foreign substances emitted from the battery such that the foreign substances are accommodated in the space.

The blocking guide may be constituted by an inclined plate formed by incising a part of the flame protection cover and bending the incised part to be inclined inwardly of the space.

The blocking guide may be constituted by a spiral plate formed by spirally incising a part of the flame protection cover and bending the incised part inwardly of the space to form a conical shape.

According to an aspect of the present disclosure, a battery case for a vehicle is provided. The battery case may comprise a case member configured to partition a battery accommodation space from an area outside the battery case, and a flame protection cover positioned between the case member and a battery accommodated in the battery accommodation space. The flame protection cover may be configured to form a space between the flame protection cover and the case member.

According to an exemplary embodiment, the flame protection cover may be positioned within the battery case such that it is spaced apart from the battery, forming a venting passage between the flame protection cover and the battery.

According to an exemplary embodiment, the space between the flame protection cover and the case member and the venting passage may be disposed in parallel to each other and positioned such that the flame protection cover is disposed between the space between the flame protection cover and the case member and the venting passage.

According to an exemplary embodiment, the flame protection cover may comprise a plurality of flame protection covers, and each flame protection cover, of the plurality of flame protection covers, may correspond to a battery module accommodated in the accommodation space.

According to an exemplary embodiment, the flame protection cover may comprise a single flame protection cover, and the battery may comprise one or more battery modules accommodated in the accommodation space, and the single flame protection cover is configured to partition the one or more battery modules from the case member.

According to an exemplary embodiment, the flame protection cover may comprise a flat plate portion configured to form the space between the flame protection cover and the case member, and a coupling portion bent from the flat plate portion and coupled to the case member.

According to an exemplary embodiment, the coupling portion may be positioned at opposite ends of the flat plate portion.

According to an exemplary embodiment, a plurality of communication holes may be formed at the flat plate portion.

According to an exemplary embodiment, the battery case may comprise a battery cell positioned with the battery case. The communication holes formed at the flat plate portion may be positioned in alignment with vent holes of the battery cell.

According to an exemplary embodiment, the battery case may comprise a battery cell positioned with the battery case. The communication holes formed at the flat plate portion may comprise a shape resembling a shape of vent holes of the battery cell.

According to an exemplary embodiment, the flat plate portion may comprise a uniform-thickness flat plate without having holes.

According to an exemplary embodiment, the battery case may comprise a fire-resistant material positioned in the space between the flame protection cover and the case member.

According to an exemplary embodiment, the battery case may comprise a fire-extinguishing material positioned in the space between the flame protection cover and the case member.

According to an exemplary embodiment, the flame protection cover may comprise a blocking guide configured to block direct exposure of the case member to flames generated in the battery and guide foreign substances emitted from the battery such that the foreign substances are accommodated in the space between the flame protection cover and the case member.

According to an exemplary embodiment, the blocking guide may comprise an inclined plate formed by incising a part of the flame protection cover and bending the incised part to be inclined inwardly of the space.

According to an exemplary embodiment, the blocking guide may comprise a spiral plate formed by spirally incising a part of the flame protection cover and bending the incised part inwardly of the space to form a conical shape.

According to an aspect of the present disclosure, a battery case system is provided. The battery case system may comprise a vehicle and a battery case, coupled to the vehicle. The battery case may comprise a case member configured to partition a battery accommodation space from an area outside the battery case and a flame protection cover positioned between the case member and a battery accommodated in the battery accommodation space. The flame protection cover may be configured to form a space between the flame protection cover and the case member.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a sectional view of a battery case for a vehicle, according to an exemplary embodiment of the present disclosure.

FIG. 2 illustrates a view of a flame protection cover, according to an exemplary embodiment of the present disclosure.

FIG. 3 illustrates a view illustrating a state in which a plurality of flame protection covers are mounted within a case member, according to an exemplary embodiment of the present disclosure.

FIGS. 4-6 illustrate views showing examples of flame protection covers, according to exemplary embodiments of the present disclosure.

FIG. 7 illustrates a view explaining functions of communication holes of a flame protection cover, according to an exemplary embodiment of the present disclosure.

FIG. 8 illustrates a view illustrating a state in which vent holes of battery cells and communication holes of the flame protection cover are aligned with each other, according to an exemplary embodiment of the present disclosure.

FIG. 9 illustrates a view illustrating an example of a flame protection cover having a flat plate portion without holes, according to an exemplary embodiment of the present disclosure.

FIGS. 10-12 illustrate views of different embodiments of the flame protection cover, according to exemplary embodiments of the present disclosure.

FIG. 13 illustrates a view illustrating an example in which a fire-resistant material is provided in a space, according to an exemplary embodiment of the present disclosure.

FIG. 14 illustrates a view illustrating an example in which a fire-extinguishing material is provided in a space, according to an exemplary embodiment of the present disclosure.

FIGS. 15-16 illustrate views illustrating a blocking guide constituted by an inclined plate, according to exemplary embodiments of the present disclosure.

FIGS. 17-18 illustrate views illustrating a blocking guide constituted by a spiral plate, according to exemplary embodiments of the present disclosure.

FIG. 19 illustrates an example architecture of a vehicle, according to an exemplary embodiment of the present disclosure.

### DETAILED DESCRIPTION

Hereinafter, the exemplary embodiment of the present disclosure will be described in detail. This exemplary embodiment is implemented based on the technical solution of the present disclosure, and shows a specific implementation method and a specific operation process, but the protection scope of the present disclosure is not limited to the exemplary embodiment below.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well-known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term "vehicle" or "vehicular" or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

It will be understood that, although the terms “first”, “second”, etc. may be used herein to describe various elements, these elements should not be limited by these terms. These terms are only used to distinguish one element from another.

The suffixes “module” and “unit” of elements herein are used for convenience of description and thus may be used interchangeably and do not have any distinguishable meanings or functions.

In the case where an element is "connected" or "linked" to another element, it should be understood that the element may be directly connected or linked to the other element, or another element may be present therebetween. Conversely, in the case where an element is "directly connected" or "directly linked" to another element, it should be understood that no other element is present therebetween.

Any number of components or a variety of components of any one of the configurations disclosed in the present disclosure may be included in the present disclosure. Such components may include any combination of characterized parts disclosed in the present disclosure, and may be arranged to constitute any one of various configurations disclosed in the present disclosure. Not only structures and arrangements of the components of the present disclosure, but also concepts as to use and operation thereof, may be applied not only to particular embodiments discussed in the present disclosure, but also to embodiments of any numbers and in any combinations. In the following description, embodiments including various characterized parts having various arrangements will be described with reference to the accompanying drawings.

Hereinafter, various embodiments disclosed in the present disclosure will be described in detail with reference to the accompanying drawings, and the same or similar elements are designated by the same reference numerals regardless of the numerals in the drawings and redundant description thereof will be omitted.

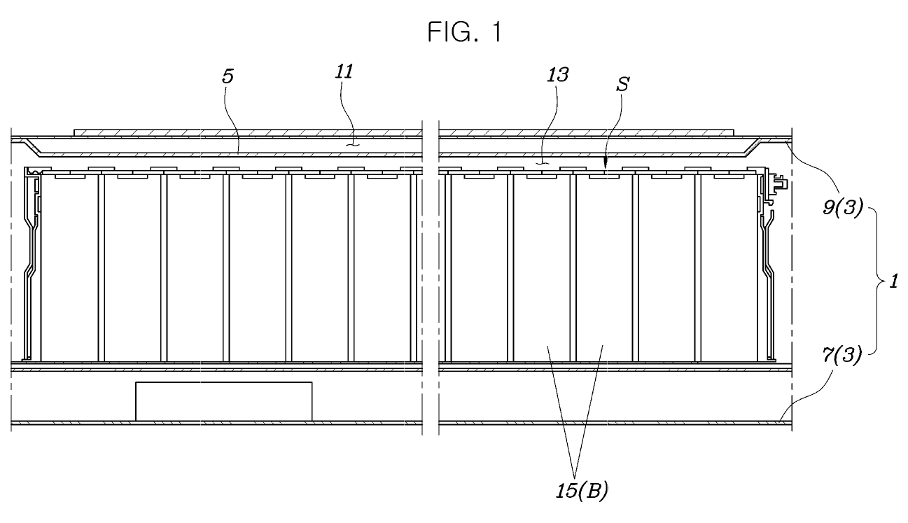

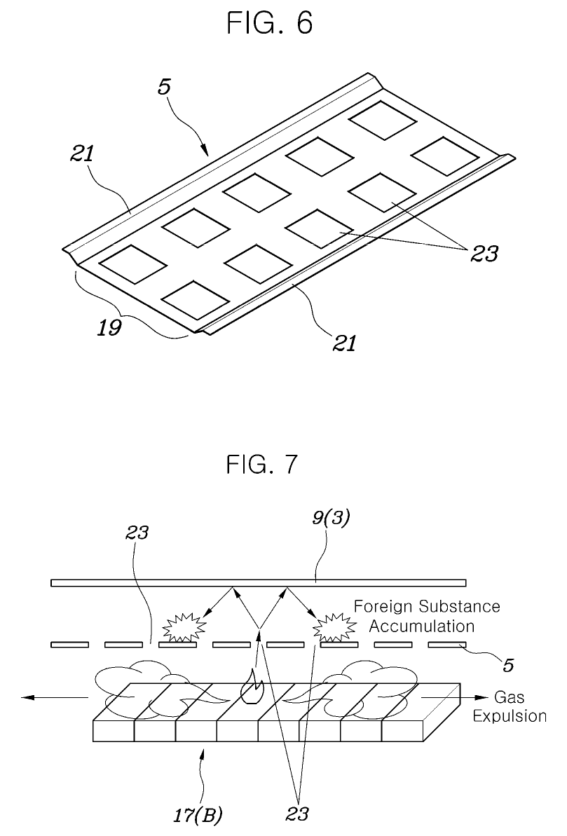

Referring now to FIGS. 1-18, a battery case 1 for a vehicle is illustratively depicted, in accordance with exemplary embodiments of the present disclosure.

According to an exemplary embodiment of the present disclosure, the battery case 1 may comprise a case member 3 configured to partition a battery accommodation space S from the outside (i.e., an area outside the battery case 1), and a flame protection cover 5 installed between the case member 3 and a battery B accommodated in the battery accommodation space S and configured to form a space 11 between the flame protection cover 5 and the case member 3.

According to an exemplary embodiment, when the battery case 1 comprises a lower case 7 and an upper case 9, the case member 3 may correspond to one or both of the lower case 7 and the upper case 9.

That is, in the present disclosure, the space 11 may be configured to be formed between the case member 3 partitioning the battery accommodation space S and the battery B by the flame protection cover 5. Accordingly, the space 11 may be configured to prevent and buffer flames generated from the battery B from being directly exposed to the case member 3 and escaping outside through the case member 3. Additionally, the space 11 may be configured to aid in preventing a painted outer surface, etc., of the case member 3 from being exposed to high temperatures and igniting.

Accordingly, it may be possible to more effectively prevent fire spread caused by fire of the battery B in the vehicle, which may be an electric vehicle or a hybrid vehicle. Ultimately, it may be possible to enhance the safety of the vehicle.

According to an exemplary embodiment, the flame protection cover 5 may be configured to be installed to be spaced apart from the battery B such that a venting passage 13 is formed between the flame protection cover 5 and the battery B. Accordingly, the battery case 1 may be configured such that gases expelled from a battery cell 15 or a battery module 17 may be quickly and smoothly discharged through the venting passage 13 and, as such, it may be possible to prevent spread of fire to other battery cells 15 or other battery modules 17 adjacent to the battery cell 15 or the battery module 17.

The space 11 and the venting passage 13 may be configured to be disposed in parallel to each other under the condition that the flame protection cover 5 is disposed between the space 11 and the venting passage 13. That is, as illustrated in FIG. 1, the flame protection cover 5 may be configured to be installed to divide the space between the battery B and the case member 3 into upper and lower parts. The space 11 may be formed at the upper part and the venting passage 13 may be formed at the lower part, resulting in a configuration in which the space 11 and the venting passage 13 are disposed in parallel to each other.

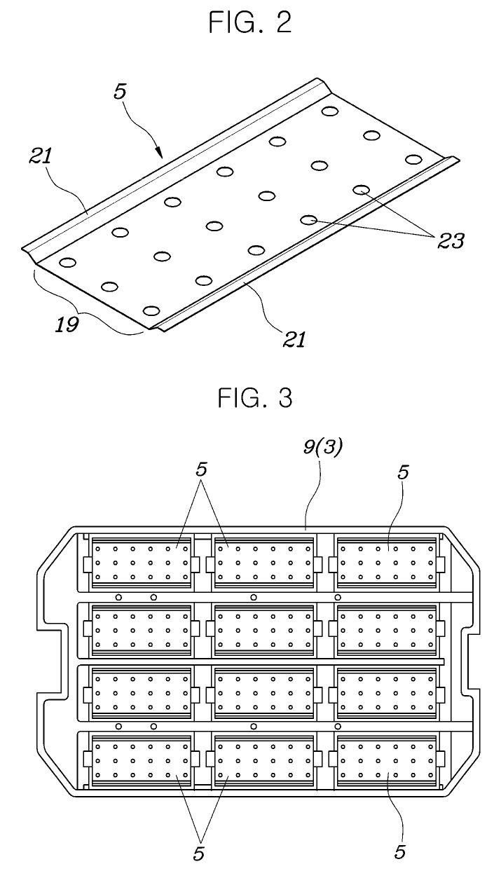

The flame protection cover 5 may be provided in plural such that a plurality of flame protection covers 5 corresponds to battery modules 17 accommodated in the accommodation space S, respectively. That is, a plurality of flame protection covers 5, each formed as shown in FIG. 2, may be disposed inside the case member 3, as shown in FIG. 3. Accordingly, it may be seen that 12 battery modules 17 accommodated in the case member 3 in FIG. 3 may be disposed in 4 rows and 3 columns in a single plane.

According to an exemplary embodiment, the flame protection cover 5 may be configured through inclusion of a flat plate portion 19 configured to form the space 11, and a coupling portion 21 bent from the flat plate portion 19 and coupled to the case member 3. In this case, the coupling portion 21 may be provided at opposite ends of the flat plate portion 19, as illustrated in FIG. 2.

Additionally, a plurality of communication holes 23 may be formed at the flat plate portion 19.

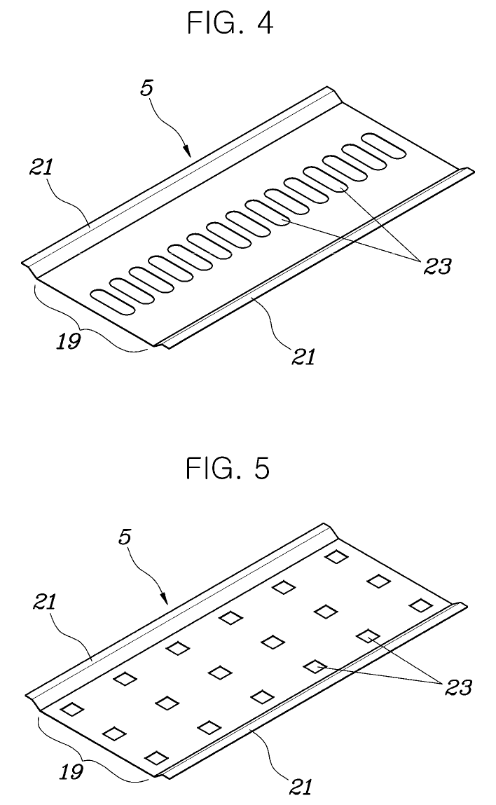

The communication holes 23 may be provided in various shapes and numbers, as illustrated, e.g., in FIGS. 4-6.

As described with reference to FIG. 7, the communication holes 23 of the flame protection cover 5 may be configured to serve to guide high-temperature conductive foreign substances expelled from the battery B due to a fire to pass therethrough and to be accumulated in the space 11 above the flame protection cover 5. This ensures that the venting passage 13 below the flame protection cover 5 is not blocked or narrowed by foreign substances described above. Accordingly, gases expelled from the battery cell 15 or the battery module 17 may be rapidly and smoothly discharged through the venting passage 13. As a result, spread of the fire to adjacent battery cells 15 or adjacent battery modules 17 may be effectively prevented.

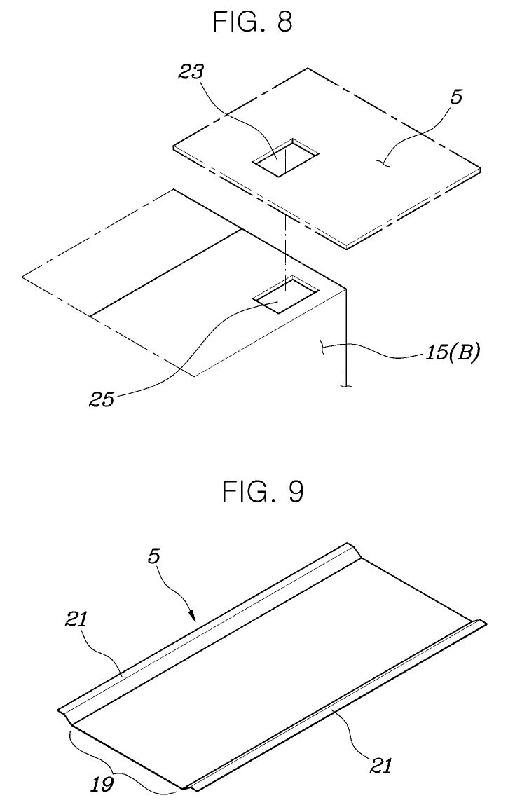

The communication holes 23 formed at the flat plate portion 19 may be disposed in alignment with vent holes 25 of the battery cell 15, and may be formed to have a shape resembling the shape of the vent holes 25 of the battery cell 15. That is, as illustrated, e.g., in FIG. 8, as the communication holes 23 are disposed in a state of being vertically aligned with square-shaped vent holes 25 formed at the battery cell 15 and are formed to have a shape resembling the square vent holes 25, foreign substances expelled from the battery cell 15 may more effectively enter the space 11 through the communication holes 23. Accordingly, it may be possible to maximize the effect of preventing foreign substances from remaining or accumulating in the venting passage 13.

Meanwhile, as illustrated in FIG. 9, the flat plate portion 19 may comprise a simple, uniform-thickness flat plate without having holes.

The flame protection cover 5 with the flat plate 19 having the above-described configuration may be configured to aid in completely preventing the case member 3 from being exposed to flames expelled from the battery B, and may be configured to aid in ensuring that the space 11 forms an insulating layer. Accordingly, it may be possible to more effectively block heat transfer to the outside of the case member 3.

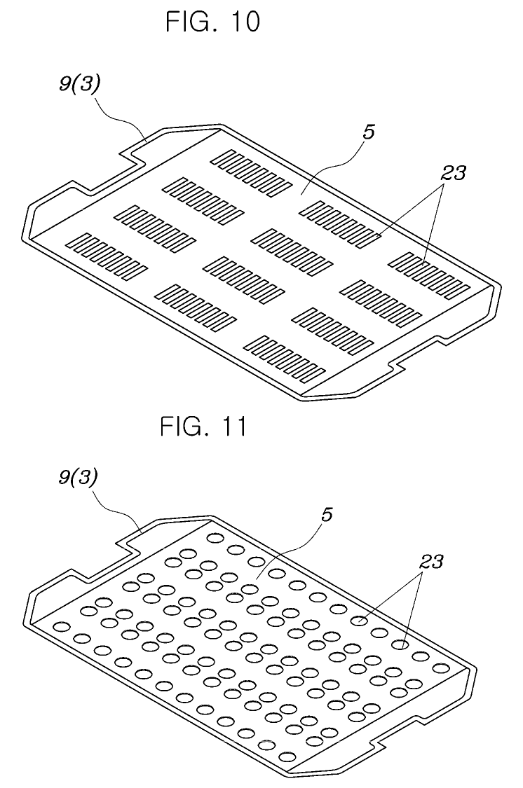

Meanwhile, as illustrated in FIGS. 10-12, the flame protection cover 5 may comprise a single member configured to partition all the battery modules 17 accommodated in the accommodation space S from the case member 3.

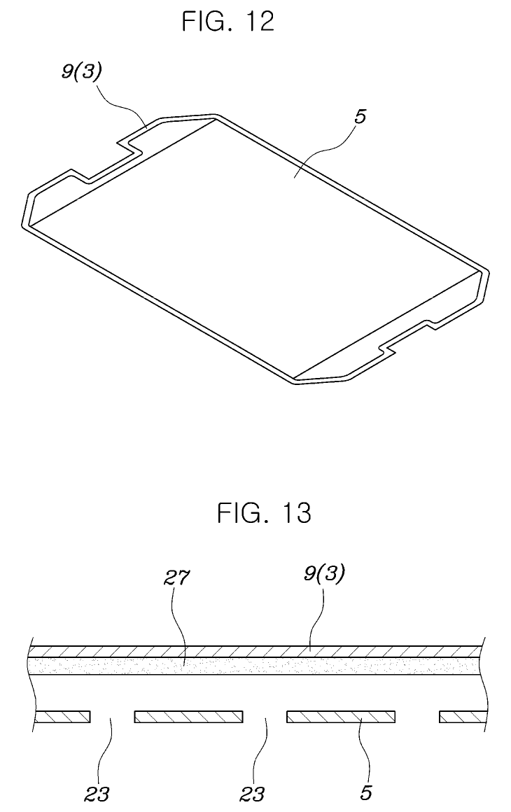

FIGS. 10 and 11 illustrate examples of the flame protection cover 5 provided with the communication holes 23, whereas FIG. 12 illustrates an example in which the flam protection cover 5 is constituted by a simple, uniform-thickness flat plate without having holes, as in the example of FIG. 9, according to exemplary embodiments of the present disclosure.

According to an exemplary embodiment, a fire-resistant material 27 may be provided in the space 11 between the flame protection cover 5 and the case member 3. That is, as illustrated in FIG. 13, the fire-resistant material 27 may be coated on the space 11 or may be inserted into the space 11 as a separate member. In this case, the function of preventing flames generated from the battery B from being spread to the outside of the case member 3 may be further enhanced.

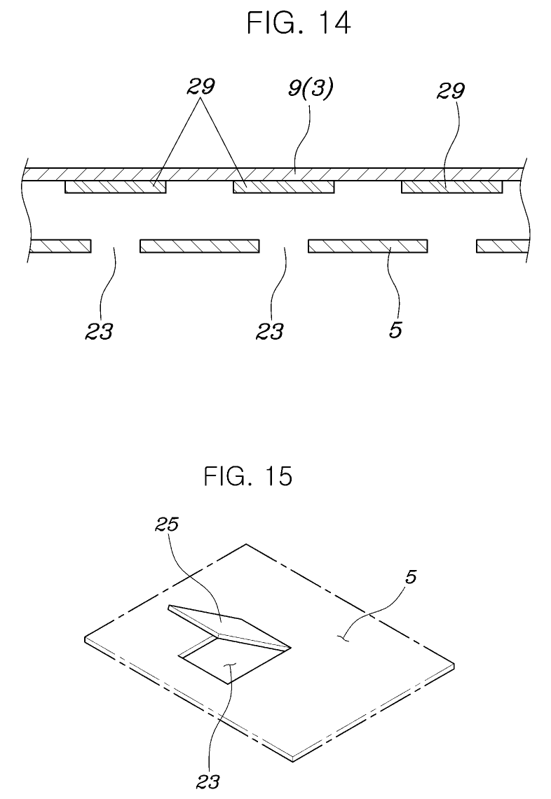

According to an exemplary embodiment, a fire-extinguishing material 29 may be provided in the space 11 between the flame protection cover 5 and the case member 3. That is, as illustrated, e.g., in FIG. 14, the fire-extinguishing material 29 may be coated on the space 11 or may be inserted into the space 11 as a separate member. In this case, as a fire occurs in the battery B and the fire-extinguishing material 29 is heated by flames, the fire-extinguishing material 29 may be configured to move downwards through the communication holes 23 to extinguish the fire in the battery B.

Meanwhile, the flame protection cover 5 may be provided with a blocking guide 31 configured to block direct exposure of the case member 3 to flames generated in the battery B and to guide foreign substances emitted from the battery B such that the foreign substances are accommodated in the space 11.

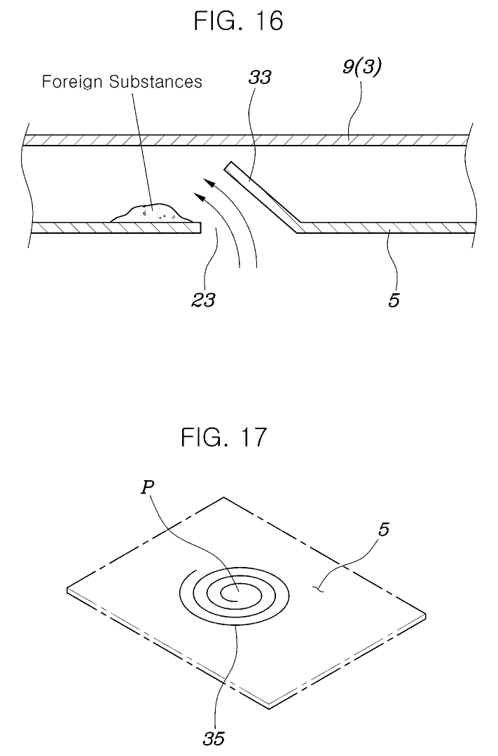

For example, as illustrated, e.g., in FIGS. 15 and 16, the blocking guide 31 may comprise an inclined plate 33 formed by incising a part of the flame protection cover 5 and bending the incised part to be inclined inwardly of the space 11.

As the blocking guide 31 described above is provided, foreign substances expelled from the battery B are effectively guided into the space 11 by the communication holes 23 and the inclined plate 33. Additionally, there is minimal exposure of the case member 3 directly to flames, enabling more reliable protection of the case member 3 from fire. Furthermore, it may be possible to more effectively prevent obstructions in the venting passage 13 caused by foreign substances.

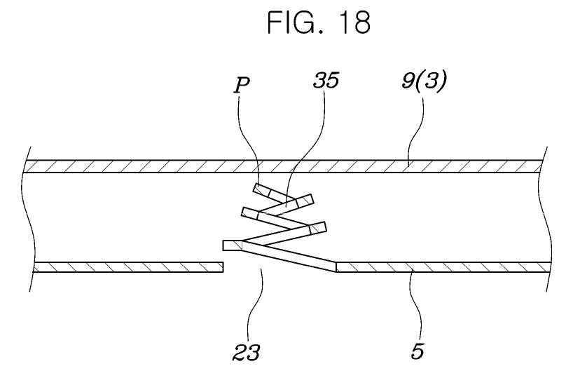

Meanwhile, the blocking guide 31 may comprise a spiral plate 35 formed by spirally incising a part of the flame protection cover 5 and bending the incised part inwardly of the space 11 to form a conical shape. For example, as shown in FIG. 17, the spiral plate 35 bent inwardly of the space 11 to form a conical shape may be formed by spirally incising a part of the flame protection cover 5, and then upwardly pulling a portion designated by “P” to deform the incised part, as shown, e.g., in FIG. 18.

The spiral plate 35 described above may be configured to disperse flames generated from the battery B to prevent the flames from directly contacting the case member 3. Additionally, the spiral plate 35 may be configured to disperse foreign substances expelled from the battery B into the interior of the space 11, thereby more effectively protecting the case member 3 from fire. Moreover, the spiral plate 35 may be configured to effectively prevent obstructions in the venting passage 13 caused by foreign substances.

As apparent from the above description, the present disclosure may be configured to prevent flames from escaping outside the battery case in the event of a fire generated from the battery module or battery cell accommodated in the battery case, and may be configured to ensure stable maintenance of the venting passage, thereby suppressing spread of the fire.

Effects attainable in the present disclosure are not limited to the above-described effects, and other effects of the present disclosure not yet described will be more clearly understood by those skilled in the art from the above description.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

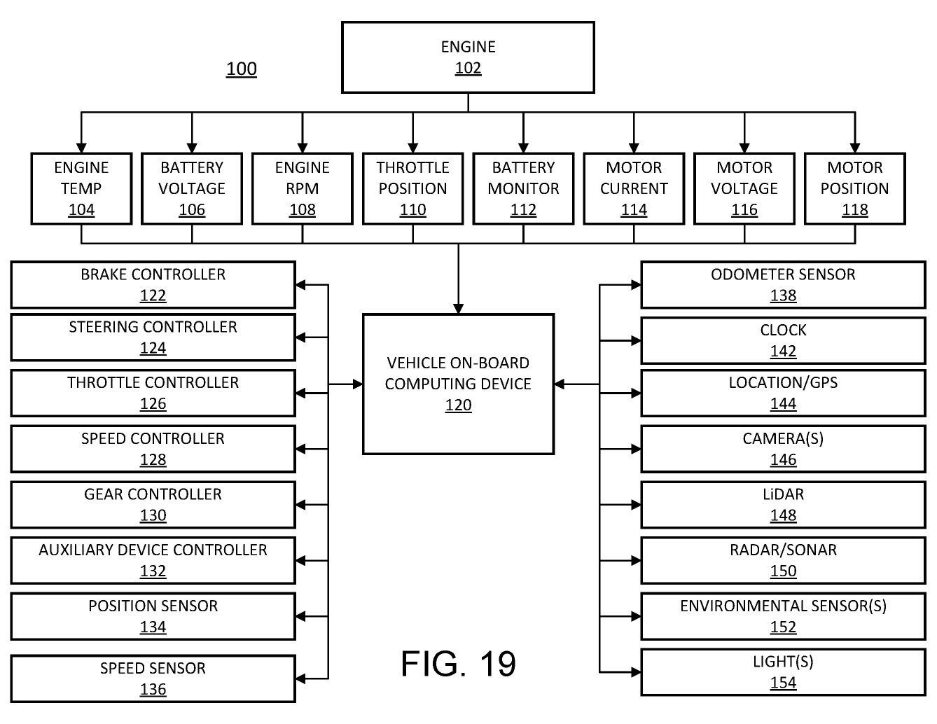

Referring now to FIG. 19, an example vehicle system architecture 100 for a vehicle is provided, in accordance with an exemplary embodiment of the present disclosure. The following discussion of vehicle system architecture 100 is sufficient for understanding one or more components of the vehicle described herein (including, e.g., the vehicle (e.g., the electric vehicle and/or hybrid electric vehicle) described above).

As shown in FIG. 19, the vehicle system architecture 100 may comprise an engine, motor or propulsive device 102 and various sensors 104-118 for measuring various parameters of the vehicle system architecture 100, such as, but not limited to, those of the vehicle snapshot described above. In gas-powered or hybrid vehicles having a fuel-powered engine, the sensors 104-118 may comprise, for example, an engine temperature sensor 104, a battery voltage sensor 106, an engine Rotations Per Minute (RPM) sensor 108, and/or a throttle position sensor 110. If the vehicle is an electric or hybrid vehicle, then the vehicle may comprise an electric motor, and accordingly may comprise sensors such as a battery monitoring system 112 (to measure current, voltage and/or temperature of the battery), motor current 114 and voltage 116 sensors, and motor position sensors such as resolvers and encoders 118.

Operational parameter sensors that are common to both types of vehicles may comprise, for example: a position sensor 134 such as an accelerometer, gyroscope and/or inertial measurement unit; a speed sensor 136; and/or an odometer sensor 138. The vehicle system architecture 100 also may comprise a clock 142 that the system uses to determine vehicle time and/or date during operation. The clock 142 may be encoded into the vehicle on-board computing device 120, it may be a separate device, or multiple clocks may be available.

The vehicle system architecture 100 may comprise various sensors that operate to gather information about the environment in which the vehicle is traveling. These sensors may comprise, for example: a location sensor 144 (for example, a Global Positioning System (GPS) device); object detection sensors such as one or more cameras 146; a LiDAR sensor system 148; and/or a radar and/or a sonar system 150. The sensors may comprise environmental sensors 152 such as, e.g., a humidity sensor, a precipitation sensor, a light sensor, and/or ambient temperature sensor. The object detection sensors may be configured to enable the vehicle system architecture 100 to detect objects that are within a given distance range of the vehicle in any direction, while the environmental sensors 152 may be configured to collect data about environmental conditions within the vehicle's area of travel. According to an exemplary embodiment, the vehicle system architecture 100 may comprise one or more lights 154 (e.g., headlights, flood lights, flashlights, etc.).

During operations, information may be communicated from the sensors to an on-board computing device 120. The on-board computing device 120 may be configured to analyze the data captured by the sensors and/or data received from data providers and may be configured to optionally control operations of the vehicle and/or vehicle system based on results of the analysis. For example, the on-board computing device 120 may be configured to control: braking via a brake controller 122; direction via a steering controller 124; speed and acceleration via a throttle controller 126 (in a gas-powered vehicle) or a motor speed controller 128 (such as a current level controller in an electric vehicle); a differential gear controller 130 (in vehicles with transmissions); and/or other controllers. The brake controller 122 may comprise a pedal effort sensor, pedal effort sensor, and/or simulator temperature sensor, as described herein.

Geographic location information may be communicated from the location sensor 144 to the on-board computing device 120, which may then access a map of the environment that corresponds to the location information to determine known fixed features of the environment such as streets, buildings, stop signs and/or stop/go signals. Captured images from the cameras 146 and/or object detection information captured from sensors such as LiDAR 148 may be communicated from those sensors to the on-board computing device 120. The object detection information and/or captured images may be processed by the on-board computing device 120 to detect objects in proximity to the vehicle. Any known or to be known technique for making an object detection based on sensor data and/or captured images may be used in the embodiments disclosed in this document.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A battery case for a vehicle, comprising:
a case member configured to partition a battery accommodation space from an area outside the battery case; and
a flame protection cover positioned between the case member and a battery accommodated in the battery accommodation space,
wherein the flame protection cover is configured to form a space between the flame protection cover and the case member.

2. The battery case according to claim 1, wherein the flame protection cover is positioned within the battery case such that it is spaced apart from the battery, forming a venting passage between the flame protection cover and the battery.

3. The battery case according to claim 2, wherein the space between the flame protection cover and the case member and the venting passage are disposed in parallel to each other and positioned such that the flame protection cover is disposed between the space between the flame protection cover and the case member and the venting passage.

4. The battery case according to claim 1, wherein:
the flame protection cover comprises a plurality of flame protection covers, and
each flame protection cover, of the plurality of flame protection covers, corresponds to a battery module accommodated in the accommodation space.

5. The battery case according to claim 1, wherein:
the flame protection cover comprises a single flame protection cover,
the battery comprises one or more battery modules accommodated in the accommodation space, and
the single flame protection cover is configured to partition the one or more battery modules from the case member.

6. The battery case according to claim 1, wherein the flame protection cover comprises:
a flat plate portion configured to form the space between the flame protection cover and the case member; and
a coupling portion bent from the flat plate portion and coupled to the case member.

7. The battery case according to claim 6, wherein the coupling portion is positioned at opposite ends of the flat plate portion.

8. The battery case according to claim 6, wherein a plurality of communication holes is formed at the flat plate portion.

9. The battery case according to claim 8, further comprising a battery cell positioned with the battery case,
wherein the communication holes formed at the flat plate portion are positioned in alignment with vent holes of the battery cell.

10. The battery case according to claim 8, further comprising a battery cell positioned with the battery case,
wherein the communication holes formed at the flat plate portion comprise a shape resembling a shape of vent holes of the battery cell.

11. The battery case according to claim 6, wherein the flat plate portion comprises a uniform-thickness flat plate without having holes.

12. The battery case according to claim 1, further comprising a fire-resistant material positioned in the space between the flame protection cover and the case member.

13. The battery case according to claim 1, further comprising a fire-extinguishing material positioned in the space between the flame protection cover and the case member.

14. The battery case according to claim 1, wherein the flame protection cover comprises a blocking guide configured to:
block direct exposure of the case member to flames generated in the battery; and
guide foreign substances emitted from the battery such that the foreign substances are accommodated in the space between the flame protection cover and the case member.

15. The battery case according to claim 14, wherein the blocking guide comprises an inclined plate formed by incising a part of the flame protection cover and bending the incised part to be inclined inwardly of the space.

16. The battery case according to claim 14, wherein the blocking guide comprises a spiral plate formed by spirally incising a part of the flame protection cover and bending the incised part inwardly of the space to form a conical shape.

17. A battery case system, comprising:
a vehicle; and
a battery case, coupled to the vehicle, the battery case comprising:
a case member configured to partition a battery accommodation space from an area outside the battery case; and
a flame protection cover positioned between the case member and a battery accommodated in the battery accommodation space,
wherein the flame protection cover is configured to form a space between the flame protection cover and the case member.

18. The battery case system according to claim 17, wherein the flame protection cover is positioned within the battery case such that it is spaced apart from the battery, forming a venting passage between the flame protection cover and the battery.

19. The battery case system according to claim 18, wherein the space between the flame protection cover and the case member and the venting passage are disposed in parallel to each other and positioned such that the flame protection cover is disposed between the space between the flame protection cover and the case member and the venting passage.

20. The battery case system according to claim 17, wherein the flame protection cover comprises:
a flat plate portion configured to form the space between the flame protection cover and the case member; and
a coupling portion bent from the flat plate portion and coupled to the case member.
